(19) United States
(12) Patent Application Publication
(10) Pub. No.: US 2025/0382142 A1
(43) Pub. Date: Dec. 18, 2025

(54) LOADING CARRIAGE FOR A LOADING SYSTEM OF A TRANSPORT UNIT

(71) Applicant: Simec Systems Oy, Oitti (FI)

(72) Inventors: Simo Aitto-Oja, Oitti (FI); Anssi Huhtala, Oitti (FI); Ville Volanen, Oitti (FI)

(21) Appl. No.: 18/743,938

(22) Filed: Jun. 14, 2024

(51) Int. Cl. B65G 67/20

(52) U.S. Cl. CPC B65G 67/20

(57) ABSTRACT

The application relates to a loading carriage for a loading system of a transport unit. The loading carriage comprises a group of carriage parts, rollers in the carriage parts, and a connection mechanism between the carriage parts. The carriage parts are configured to establish a roller bed. The rollers are configured to roll the roller bed forwards and backwards with respect to a surface below the roller bed. The connection mechanism is configured to connect the carriage parts so that each carriage part is configured pivot by means of the connection mechanism with respect to at least one adjacent carriage part to cause the roller bed flexible in a longitudinal direction. The carriage parts, which are parallel in the longitudinal direction and belong to the group of the carriage parts, are connected by means of stabilizers to stabilize the parallel carriage parts vertically with respect to each other.

### TECHNICAL FIELD

The application relates generally to a loading carriage for a loading system of a transport unit.

### BACKGROUND

A known one-shot loading system for loading palletized or non-palletized goods to a cargo space of a transport container comprises a chassis and a carriage mounted on the chassis so that the carriage can move along the chassis to the transport container and back. The known loading system further comprises a buffer structure, which comprises a buffer beam and a massive lifting gate structure to lift and to lower the buffer beam vertically, at a loading end of the chassis.

The goods are loaded successively on the carriage, which is then driven through the lifting gate structure, when the buffer beam has been lifted up, to the transport container. When the goods are inside the transport container, the buffer beam is lowered in the lifting gate structure to contact and to support an end of successively loaded goods. The conveyor is driven out from under the goods while the end of the goods is supported by the lowered buffer beam as long as the conveyor is under the goods.

When the conveyor has been driven out from the transport container and the goods are in the transport unit, the buffer beam is lifted by the lifting gate structure and the loading system is again ready for a next loading operation.

### SUMMARY

One object of the invention is to withdraw the drawbacks of known solutions and to provide a loading carriage for a one-shot loading operation that comprises carriage parts connected to each other so that the structure of the loading carriage adapts to a roughness of a floor of a transport unit but it still is sufficiently rigid to support a load above it and prevents a wrinkling of a rear part of the loading carriage when the loaded loading carriage is driven towards the transport unit.

One object of the invention is fulfilled by providing the loading carriage and loading system according to the independent claims.

Embodiments of the invention are disclosed in the independent claims.

One loading carriage for a loading system of a transport unit comprises a group of carriage parts, rollers in the carriage parts, and a connection mechanism between the carriage parts. The carriage parts are configured to establish a roller bed. The rollers are configured to roll the roller bed forwards and backwards with respect to a surface below the roller bed. The connection mechanism is configured to connect the carriage parts so that each carriage part is configured pivot by means of the connection mechanism with respect to at least one adjacent carriage part to cause the roller bed flexible in a longitudinal direction. The carriage parts, which are parallel in the longitudinal direction and belong to the group of the carriage parts, are connected by means of stabilizers to stabilize the parallel carriage parts vertically with respect to each other so that the roller bed is sufficiently rigid laterally.

One loading system comprises a chassis, the previous loading carriage, and a buffer device, wherein the loading carriage and the buffer device are mounted on the chassis.

### BRIEF DESCRIPTION OF THE FIGURES

The exemplary embodiments of the invention are explained with reference to the accompanying figures:

FIG. 1 presents a loading system without a buffer device

FIG. 2 presents the loading system when a loading carriage is loaded with palletized goods

FIG. 3 presents the loading system when the loaded loading carriage has been driven into a transport unit

FIG. 4 presents the loading system when the buffer device has been lowered to buffer the load for a retraction of the loading carriage from the transport unit

FIG. 5 presents the loading system when the loading carriage has been retracted from the loaded transport unit and details of the loading carriage

FIG. 6 presents a carriage part and its cross section A-A

### DETAILED DESCRIPTION OF THE FIGURES

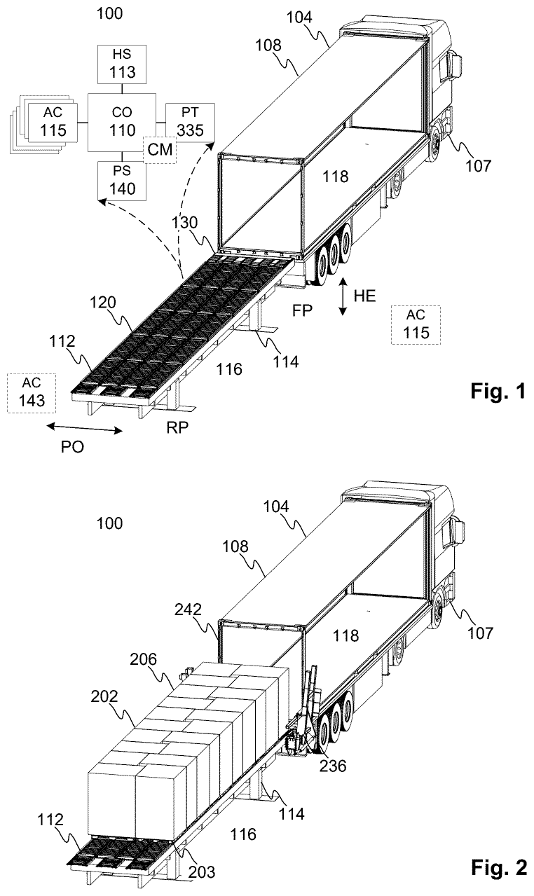

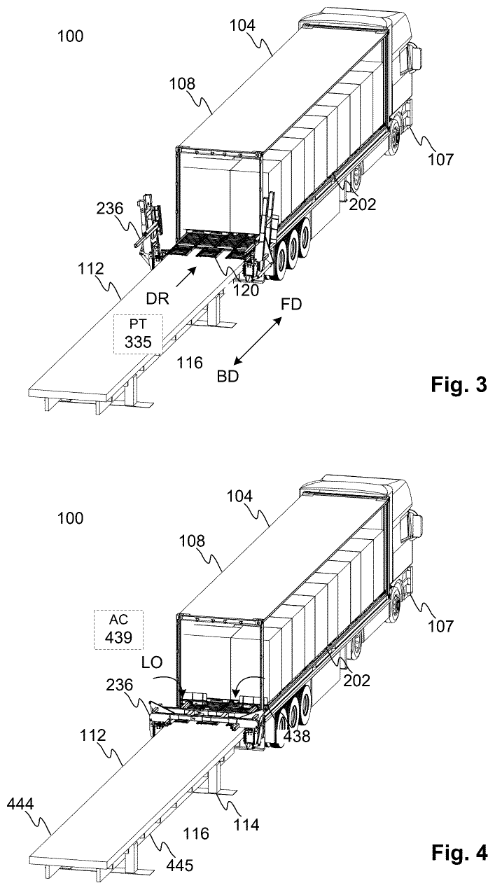

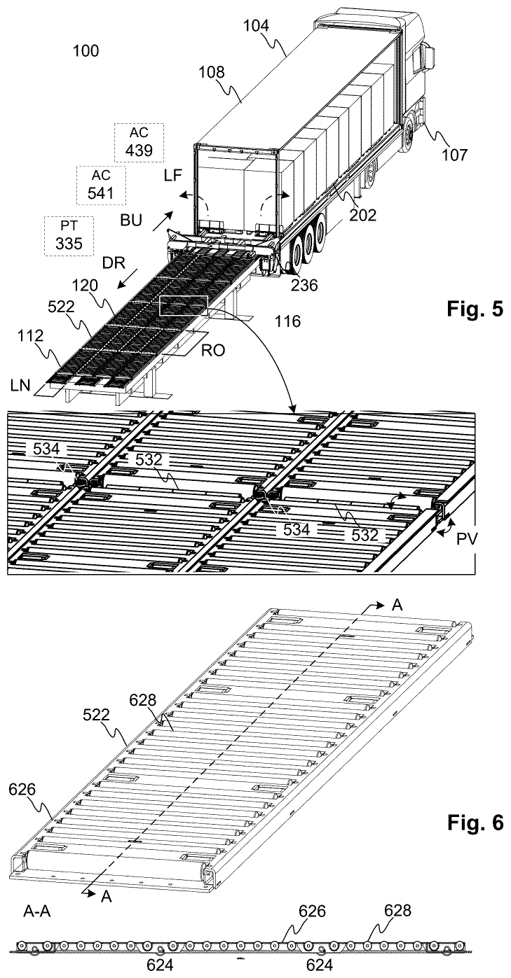

FIG. 1-6 present a loading system 100 for loading a palletized and non-palletized load 202 into a transport unit 104 in a one-shot loading operation and its details. The load 202 comprises at least one good 206, e.g., one, two, three, four, or more goods, on each pallet 203.

The transport unit 104 comprises an unmodified cargo space, e.g., an open cargo space (transport platform) of a truck 107 or a trailer, closed cargo space (container) 108 of the truck 107 according to the figure, closed cargo space of the trailer, or a freight container.

The loading system 100 comprises a controller 110 that is configured to control operating parts of the loading system 100, e.g., parts 115, 120, 143, 236, 335, 439, 541, and a buffer beam (not presented) to operate the loading system 100.

The controller 110 comprises a processor configured to carry out operator-initiated instructions, computer program initiated instructions, or both and to process information to run computer programs. The processor comprises at least one processor, e.g., one, two, three, four, or more processors.

The controller 110 further comprises a memory configured to store and to maintain information. The information comprises, e.g., instructions, computer programs CM, and information files. The memory comprises at least one memory, e.g., one, two, three, four, or more memories.

The processor together with the memory, which stores a computer program CM to operate the loading system 100, are configured to control the loading system 100 and its parts 115, 120, 143, 236, 335, 439, 541 and the buffer beam so that the loading carriage 100 carries out the operations that have been explained previously and later on.

The loading system 100 further comprises a chassis 112 that is configured to establish a support structure, a mounting structure, and a protective structure for the parts 110, 115, 120, 143, 236, 335, 439, 541, and the buffer beam of the loading system 100.

The chassis 112 comprises legs 114 that are configured to mount the loading system 100, i.e., the chassis 112, on a mounting platform (surface) 116 and to adapt a height of the chassis 112 to match (level) the chassis 112 and a floor (bottom surface) 118 of the transport unit 104 according to the figures.

The loading system 100 further comprises a light sensor 113, e.g., two laser sensors, mounted in the front part FP of the chassis 112. The light sensor 113 is configured to sense a height of the floor 118.

Each leg 114 comprises a height adjustment actuator 115, e.g., a hydraulic, electric belt-driven, rack and pinion-driven, gearwheel-driven, electric cylinder, or pneumatic actuator, that is configured to adjust a height of the chassis 112, i.e., a height of an upper (table) structure 444 of the chassis 112 to which a loading carriage (roller bed) 120 together with a buffer device 236 and the buffer beam is connected. The adjustment is carried out vertically, i.e., in a vertical direction, with respect to other structures 445 of the chassis 112, e.g., the legs 114 and other lower structures under the upper structure 444. The adjustment is further carried out vertically with respect to the mounting platform 116, and the floor 118. The loading system 100 is configured to position HE the loading carriage 120 with the connected parts 236 vertically so that it matches with the floor 118 on the grounds of height information from the light sensor 113.

The loading system 100 further comprises said loading carriage 120 mounted on the chassis 112 so that it rests on an upper part of the chassis 112 and can move along the chassis 112. The loading carriage 120 is configured to move, to carry the load 202, and to drive the load 202 at least forwards, i.e., in a forward (loading) direction FD. The loading carriage 120 is further configured to move backwards, i.e., in a backward (retracting) direction BD, which is opposite the forward direction FD, after it has left the load 202 in the transport unit 104.

The loading carriage 120 comprises a group of carriage parts 522. which are arranged in a row RO so that each carriage part 522 belongs to one row RO and the rows RO are arranged successively so that each carriage part 522 belongs to one line LN according to the figures. The carriage parts 522 are configured to establish a so-called roller bed 120.

Each carriage part 522 comprises rollers 624, which are integrated in a frame 626 of the carriage part 522 so that the rollers 624 emerge from a lower structure of the frame 626 as well as the rollers 624 project from the upper structure of the frame 626 to establish a low profile of the frame 626 as well as the loading carriage 120. The rollers 624 are configured to roll (move) together with other rollers 624 of other carriage parts 522 the loading carriage 120 with respect to a surface below the loading carriage 120, e.g., on the chassis 112 along its structure as well as along the floor 118 forwards and backwards.

The loading carriage 120 further comprises load rollers 628, which are integrated in the frame 626 so that load rollers 628 emerge from an upper structure of the frame 626. All load rollers 628 are configured to roll the load 202 forwards with respect to the loading carriage 120. A part of the load rollers 628 are also configured to roll the loading carriage 120 together with the rollers 624 along a below surface of the load 202 above the loading carriage 120 backwards when the loading carriage 120 is retracted from under the load 202. Another part of the load rollers 628, which are positioned between the forwards-backwards rolling load rollers 628, cannot roll backwards, which prevents the load 202 to move accidentally backwards on the loading carriage 120.

The loading carriage 120 comprises the first parallel carriage parts 522, i.e., the first row RO in a forward direction FD, in its front part (end) FP, which are adjacent sideways. The carriage parts 522 in the first row RO comprise a vertically lowered profile to facilitate a retraction of the loading carriage 120 from under the load 202. The front part FP may alternatively comprise a uniform single carriage part (not presented), which comprises a vertically lowered profile correspondingly to facilitate the retraction of the loading carriage 120 from under the load 202.

The loading carriage 120 further comprises a ramp 130 mounted at the front part FP of the loading carriage 120, which is in the forward direction FD. The ramp 130 is configured to incline the load 202, at least a last good 206 when the loading system 100 drives the loading carriage 120 out from under the load 202 (last good 206) in the backward direction BD.

The loading carriage 120 further comprises a connection mechanism 532, e.g., a hinge mechanism, flexible structure, or other motion-enabling mechanism, between the successive carriage parts 522 that is configured to connect the successive carriage parts 522 in the line LN. The connection mechanism 532 is configured to connect the successive carriage parts 522 so that each carriage part 522 is configured pivot PV by means of the connection mechanism 532 with respect to at least one successively adjacent carriage part 522, e.g. one or two adjacent carriage parts 522, in the longitudinal direction to cause the loading carriage 120 flexible in a longitudinal direction and vertically.

The connection mechanism 532 further comprises bracing elements (not presented), e.g., metal plates, stabilizers, or other bracing elements, at least between first two, i.e., first and second, successive rows RO of the carriage parts 522 in a backward direction BD, which are adjacent in the longitudinal direction. The bracing elements are installed, e.g., between first two, three, four, or five successive rows RO from a rear part RP of the loading carriage 120. The bracing elements brace the carriage parts 522 in the longitudinal direction and prevents a wrinkling of the rear part RP especially when the loading carriage 120, which is not loaded completely by goods 203, i.e., the loading carriage is half loaded, is driven in the forward direction FD.

The loading carriage 120 further comprises stabilizers 534, e.g., anti-roll bars or other stabilizing mechanisms, between the carriage parts 522 in rows RO, which are parallel in the longitudinal direction and adjacent sideways. The stabilizers 534 are configured to connect and to stabilize the parallel carriage parts vertically with respect to each other so that the loading carriage 120 is sufficiently rigid laterally.

The loading system 100 further comprises a power transmission system 335, e.g., an electric motor, configured to drive DR the loading carriage 120 by means of the rollers 624 forwards and backwards with respect to other structures of the chassis 112 on the grounds of control commands from the controller 110.

The loading system 100 further comprises a buffer device 236 mounted on the chassis 112 so that the buffer device 236 rests on the upper part of the chassis 112 and it is connected to the chassis 112 in its front part FP. The buffer device 236 is configured to buffer the load 202 when the loading carriage 120 is retracted backwards from under the load 202. The buffer device 236 allows the loading carriage 120 to move through it, to buffer the load 202, and to restrain the load 202, when the loading system 100 drives the loading carriage 120 out from under the load 202 in the backward direction BD.

The buffer device 236 comprises a lifting mechanism 438 with a buffering element (beam) according to the figures on both sides of the chassis 112. The buffer device 236 allows the loading carriage 120 to move through it by lifting (pivoting) LF the lifting mechanisms 436 with the buffering elements in an upper position and buffers the load 202 by lowering (pivoting) LO the lifting mechanisms 438 in a lower position above the chassis 112 and buffering the load 202 by the buffering elements when the loading carriage 120 is retracted from the transport unit 104.

The buffer device 236 may alternatively comprise a lifting gate mechanism (not presented) with a single buffering beam instead of the lifting mechanism 438, whereupon the buffering beam, which is mounted on the lifting gate mechanism, moves vertically in the upwards and downwards between the structures of the lifting gate mechanism and buffers the load 202 by the buffering element correspondingly as the previously explained buffering elements in the lifting mechanism 438. The buffer device 236 may alternatively comprise a lifting mechanism with a buffering beam (not presented), which has been disclosed in application U.S. Ser. No. 18/501,611.

The loading system 100 further comprises a lifting actuator 439 and a buffer actuator 541, e.g., hydraulic, electric belt-driven, rack and pinion-driven, gearwheel-driven, electric cylinder, or pneumatic actuators, mounted in the chassis 112. The actuator 439 is configured to lift LF and to lower LO the lifting mechanisms 438. The actuator 541 is configured to move BU the buffering elements forwards and backwards with respect to other structures of the chassis 112 on the grounds of control commands from the controller 110.

The loading system 100 further comprises said buffer beam (not presented) mounted on the chassis 112 so that the buffer beam rests on the upper part of the chassis 112 and it is connected to the chassis 112 in its rear part RP. The buffer beam is configured to buffer the load 202 forwards by means of the load rollers 628 with respect to the loading carriage 120 when the load 202 is formed (preloaded) on the loading carriage 120 and restrained on the loading carriage 120 before the load 202 is driven to the transport unit 104.

The loading system 100 further comprises a beam actuator (not presented), e.g., a hydraulic, electric belt-driven, rack and pinion-driven, gearwheel-driven, electric cylinder, or pneumatic actuator, mounted in the chassis 112. The beam actuator is configured to drive the buffer beam forwards and backwards with respect to other structures of the chassis 112 on the grounds of control commands from the controller 110.

The loading system 100 further comprises a position light scanner 140 mounted in the front part FP of the chassis 112. The light scanner 140 is configured to sense positions of walls 242 of the transport unit 104.

The loading system 100 further comprises a lateral adjustment actuator 143, e.g., a hydraulic, electric belt-driven, rack and pinion-driven, gearwheel-driven, electric cylinder, or pneumatic actuator, mounted in the chassis 112. The actuator 143 is configured to adjust a position of the upper structure 444 of the chassis 112 laterally with respect to other structures 445 of the chassis 112 under the upper structure 444. The loading system 100 is configured to position PO the loading carriage 120 with the buffer device 236 and the buffer beam laterally between the walls 242 on the grounds of position information from the light scanner 140.

The one-shot loading operation is carried by the loading system 100 mutatis mutandis correspondingly as by means of the known one-shot loading system, which has been explained previously in the background.

The invention has been now explained with reference to the above exemplary embodiments and its several advantages have been demonstrated. It is clear that the invention is not only restricted to these embodiments, but it comprises all possible embodiments within the scope of the following claims.

1. A loading carriage for a loading system of a transport unit, comprising
a group of carriage parts,
rollers in the carriage parts, and
a connection mechanism between the carriage parts,
which carriage parts are configured to establish a roller bed,
which rollers are configured to roll the roller bed forwards and backwards with respect to a surface below the roller bed, and
which connection mechanism is configured to connect the carriage parts so that each carriage part is configured pivot (PV) by means of the connection mechanism with respect to at least one adjacent carriage part to cause the roller bed flexible in a longitudinal direction,
wherein carriage parts, which are parallel (RO) in the longitudinal direction and belong to the group of the carriage parts, are connected by means of stabilizers to stabilize the parallel carriage parts vertically with respect to each other so that the roller bed is sufficiently rigid laterally.

2. The loading carriage according to claim 1, which stabilizers are connected between the parallel carriage parts, which are adjacent sideways.

3. The loading carriage according to claim 1, wherein the connection mechanism comprises a hinge mechanism between the successive (LN) carriage parts, which are adjacent in the longitudinal direction and belong to the group of the carriage parts.

4. The loading carriage according to claim 1, wherein the connection mechanism further comprises bracing elements at least between a first and second successive carriage parts in a backward direction (BD), which are adjacent in the longitudinal direction and belong to the group of the carriage parts, to prevent a wrinkling of a rear part of the roller bed when the loaded roller bed is driven in a forward direction (FD).

5. The loading carriage according to claim 1, wherein a front part of the roller bed comprises first parallel carriage parts in a forward direction (FD), which are adjacent sideways, belong to the group of the carriage parts, and comprise a vertically lowered profile to facilitate a retraction of the roller bed from under a load or a uniform single carriage part, which belongs to the group of the carriage parts and comprises a vertically lowered profile, to facilitate the retraction of the roller bed from below the load.

6. The loading carriage according to claim 1, wherein the rollers comprises integrated rollers in each carriage part, which are configured to roll the roller bed along the surface below the roller bed.

7. The loading carriage according to claim 1, wherein each carriage part comprises integrated load rollers, which are configured to move a load with respect to the roller bed.

8. The loading carriage according to claim 7, wherein a part of the load rollers are configured to roll only forwards to prevent the load to move backwards on the loading carriage.

9. The loading carriage according to claim 1, wherein the roller bed is configured to be mounted on a chassis.

10. The loading carriage according to claim 9, which chassis comprises a light sensor configured to sense a height of a floor of the transport unit and at least one height adjustment actuator configured to adjust a height of the roller bed vertically with respect to the mounting platform to level heights of the floor of the transport unit and the roller bed on the grounds of height information from the light sensor.

11. The loading carriage according to claim 9, which chassis comprises a lateral adjustment actuator configured to adjust a position of the roller bed laterally with respect to the chassis and a light scanner configured to sense positions of walls of the transport unit to position the roller bed laterally between the walls of the transport unit on the grounds of position information from the light scanner.

12. The loading carriage according to claim 9, which chassis comprises a buffer device configured to buffer a load when the roller bed is retracted in a backward direction (BD) from under the load.

13. The loading carriage according to claim 9, which chassis comprises a buffer beam configured to buffer a load in a forward direction (FD) with respect to the roller bed when the load is loaded on the roller bed.

14. The loading carriage according to claim 9, which chassis comprises a controller configured to control at least one actuator configured to move the roller bed vertically and laterally and a power transmission configured to drive the roller bed forward and backward directions (FD, BD).

15. A loading system for loading a transport unit, comprising a chassis, a loading carriage according to claim 1, and a buffer device, wherein the loading carriage and the buffer device are mounted on the chassis.
